(19) United States
(12) Patent Application Publication
(10) Pub. No.: US 2002/0164521 A1
(43) Pub. Date: Nov. 7, 2002

(54) Novel applications of exfoliated transition metal dichalcogenides to electrochemical fuel cells

(75) Inventors: Silvia Wessel, Coquitlam (CA); David P. Wilkinson, North Vancouver (CA); Sharon C. Thomas, Vancouver (CA); Kevin M. Colbow, North Vancouver (CA); Shanna D. Knights, Burnaby (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power System Inc., Burnaby (CA)

(21) Appl. No.: 10/114,660

(22) Filed: Apr. 2, 2002

Related U.S. Application Data
(60) Provisional application No. 60/282,320, filed on Apr. 5, 2001.

(51) Int. Cl. H01M 4/86; B05D 5/12; H01M 4/88

(52) U.S. Cl. 429/40; 429/44; 502/101; 427/115

(57) ABSTRACT

Application of two-dimensional materials (TDMs) that are exfoliated transition metal dichalcogenides in electrochemical fuel cells to remove contaminants that are harmful to the fuel cells; to effect proper transport and containment of various fluids in fuel cells to achieve proper and efficient operation; to protect various surfaces and materials commonly comprised in or used for fuel cells and critical to their operation; and to purify and lower the freezing point of cooling water used for the fuel cell stacks. Disclosed are methods whereby the TDM is used as a barrier to prevent unwanted crossover (between electrodes through a polymer electrolyte membrane or PEM) of chemical species; where the TDM is used to coat and/or encapsulate catalyst particles, carbon catalyst support, PEMs, and chemical or metal hydrides, to protect the same from unwanted exposure to chemical species; and where the TDM is used to purify and lower the freezing point of fuel cell stack cooling water. Also disclosed are products related to the above and comprising the TDM.

### BACKGROUND OF THE INVENTION

1. Technical Field

This invention relates generally to electrochemical fuel cells, particularly those that use proton-exchange membranes as the electrolyte and methanol or hydrogen as the fuel, the hydrogen being supplied directly or by a fuel processing unit integrated with the electrochemical fuel cell.

2. Description of the Related Art

The generation of electrical power using electrochemical fuel cells is a rapidly emerging technology. In general terms, a fuel cell converts a fuel, such as hydrogen or methanol, and oxygen into electricity and water. Its key components are an anode, electrolyte, and cathode. Fuel cells are often classified according to the type of electrolyte that they use. Accordingly, there are alkaline, acid, molten carbonate, solid oxide, and polymer electrolyte membrane (PEM) fuel cells. Fuel cells that use a PEM as the electrolyte are often favored as they are less expensive to manufacture than other types of fuel cells, are more efficient and practical for transportation and smaller-scale applications, operate at relatively low temperatures (typically about 80° C.), achieve high power densities, and can respond rapidly to changes in load.

The PEM, a thin polymeric film, is “sandwiched” between, and in intimate contact with, the anode and cathode. Each electrode is coated on one side with a thin layer of catalyst—typically platinum (Pt) or a Pt alloy. The PEM is in contact with the catalyst layers. Typically, the catalyst layer comprises carbon particles as a catalyst support. The anode/PEM/cathode combination is referred to as the membrane electrode assembly (MEA). The MEA is sandwiched between separator plates, or fluid flow field plates, that contain passageways for fuel streams, product streams, and coolant. A plurality of fuel cells are typically stacked in series to form a fuel cell stack.

At the anode/PEM interface, hydrogen gas dissociates into protons and electrons, or, if methanol is used as the fuel, methanol reacts with water to yield protons, electrons, and carbon dioxide. The PEM conducts protons from the anode to the cathode when hydrated, which is typically accomplished by humidifying the fuel and oxidant streams. The PEM, when intact, is generally effective in not allowing hydrogen fuel and oxidant streams to mix. However, the PEM does allow crossover of water between the anode and cathode in either direction, and, when methanol is used as the fuel, or otherwise present, crossover of methanol from the anode to the cathode is possible. Also, the PEM does not conduct electrons, which are thereby forced to bypass the electrolyte through an external circuit to reach the cathode, thus generating electrical current. Electrons, protons and oxygen combine at the cathode to form water in an exothermic reaction. Cooling is provided, typically by passing water through passages that are internal to the separator plates.

Direct utilization of hydrogen is often not favored for fuel cells because of difficulties associated with its handling and distribution. However, most fuel cells are designed to oxidize hydrogen at the anode. Therefore, fuel cell power plants often incorporate a fuel processor to produce hydrogen from hydrocarbon fuel, typically by steam reforming. The hydrogen-rich reformate stream fed to the fuel cell comprises carbon dioxide, methanol, and small amounts of carbon monoxide. Another approach is to directly feed an aqueous solution of methanol to a so-called direct methanol fuel cell (DMFC). Where hydrogen is used directly as fuel for fuel cells, it is either supplied as a compressed gas, or, to alleviate safety concerns, it is supplied as a component of metal hydrides.

A number of technical challenges, associated with the above-described technology, require solutions superior to those heretofore proposed. There is a general need to purify hydrogen fed to fuel cells, particularly when it is provided as a hydrogen-rich stream from a fuel processor. Contaminants in fuel streams can contaminate surfaces of porous structures comprised in electrodes, PEM microchannels, and the catalyst. For example, even trace amounts of CO in the fuel stream can poison the Pt catalyst. Additionally, the carbon catalyst support may be oxidized, either due to unusual operating conditions, or simply over an extended period, leading to loss of supported catalyst and flooding of catalyst layers. Further, when methanol is used in a DMFC or is present in H₂-rich reformate streams, it may pass through the PEM from the anode to the cathode, resulting in the loss of fuel and/or less efficient operation of the cathode. Also, there may be water management problems in the MEA, including flooding of surfaces and associated loss of critical mass transport of reactant and product species, as well as poor water retention by the PEM, resulting in the loss of proton conductivity and performance, as well as localized dehydration and cracking of the PEM. In addition, the reliability of the PEM may be compromised due to thinning and formation of holes and cracks, resulting in unwanted gas transfers. This problem may stem from chemical attack of the PEM or solubilization of the PEM at higher temperatures and in the presence of, as one example, methanol. Where chemical and metal hydrides are used to more conveniently allow direct utilization of hydrogen as a fuel, there are problems associated with the sensitivity of chemical hydrides to moisture and the contamination of metal hydrides by various impurity gases. Finally, where water is used to cool fuel cell stacks, there are problems associated with contamination of the water and with the water freezing in low temperature operation.

Accordingly, there remains a need in the art for removing and/or excluding contaminants that are harmful to fuel cells, for properly transporting and containing various fluids, particularly water and methanol, in fuel cells, and for protecting surfaces and materials commonly comprised in fuel cells. This invention fulfills these needs, and provides further related advantages.

### BRIEF SUMMARY OF THE INVENTION

In brief, this invention is directed to the application of exfoliated transition metal dichalcogenides in fuel cells to remove contaminants that are harmful to the fuel cells, to effect proper transport and containment of various fluids in fuel cells to achieve proper and efficient operation, to protect various surfaces and materials commonly comprised in or used for fuel cells and critical to their operation, and to purify and lower the freezing point of fuel cell stack cooling water.

All embodiments of this invention are directed to the application of exfoliated transition metal dichalcogenites, such as Lightyear's two dimensional material (TDM) comprising MoS₂. Other exfoliated transition metal dichalcogenides may also be used. In one embodiment, TDM is applied to a porous membrane, the membrane comprising the TDM being used to purify and enrich a H₂ fuel stream. In a further embodiment, TDM is used to encapsulate the Pt catalyst comprised in fuel cells to prevent poisoning of the catalyst by CO and CO₂. In another embodiment, TDM is used to coat catalyst carbon support material on the anode to prevent oxidation of the support material during cell reversal. Also, TDM is used to coat catalyst carbon support material on the cathode to prevent oxidation over time of the latter support material. Yet another embodiment is directed to the application of TDM monolayers at the interface of the PEM and one of the catalyst layers comprised in the MEA to act as a barrier to the transport of water, methanol, O₂, and CO₂ across the PEM. Alternatively, for the same purpose, TDM is sandwiched as a monolayer between two sheets of the PEM. Another embodiment is directed to coating or impregnating the PEM to prevent thinning of, and/or formation of holes or cracks in, the PEM due to chemical attack and solubilization. Another embodiment is directed to the encapsulation of chemical hydrides for moisture stability and to the encapsulation of metal hydrides to protect the latter from contamination by impurity gases.

In yet another embodiment, cooling water used for fuel cells is purified by passing the cooling water through a TDM filter, or by suspending the TDM in the cooling water. Also, a TDM suspension is used to lower the freezing point of the cooling water. Generally, embodiments of this invention are directed to the application of TDM in methods for achieving the above-described purposes of this invention, as well as to components of fuel cells that comprise the TDM.

Finally, in further embodiments, products related to the above applications of TDM are disclosed, as are MEAs that comprise one or more of such products, and fuel cells that contain such MEAs.

These and other aspects of this invention will be evident upon reference to the following detailed description and attached drawings. To this end, a number of patent documents are cited hereinto to aid in understanding certain aspects of this invention. Such documents are hereby incorporated by reference in their entirety.

### BRIEF DESCRIPTION OF THE DRAWINGS

FIG. 1 illustrates catalyst particles having a two-dimensional material (TDM) deposited thereon.

FIG. 2 illustrates a polymer electrolyte membrane (PEM) with a deposited layer of TDM.

FIG. 3 illustrates protecting chemical or metal hydride particles via encapsulation by TDM.

FIG. 4 illustrates the application of TDM to purify a fluid by trapping ions, molecules, and/or particles between adjacent TDM sheets.

### DETAILED DESCRIPTION OF THE INVENTION

As noted above, this invention is generally directed to the application of exfoliated transition metal dichalcogenides in fuel cells to remove contaminants that are harmful to the fuel cells, to effect proper transport and containment of various fluids in fuel cells to achieve proper and efficient operation, and to protect various surfaces and materials commonly comprised in fuel cells and critical to their operation. Products and methods related to such application of exfoliated transition metal dichalcogenides are also disclosed and discussed in greater detail below.

This invention is directed to novel applications to fuel cells of two-dimensional materials (TDMs) that are exfoliated transition metal dichalcogenide monolayers. Such materials are known in the art (see U.S. Pat. Nos. 4,299,892; 4,647,386; 4,822,590; 4,996,108; and Journal of the American Chemical Society, 121: 11720-11732, 1999), and their use as a passivating material for the negative electrode of an electrochemical storage cell has been disclosed (see U.S. Pat. No. 5,932,372). One example, applicable to this invention, is a TDM comprising MoS₂, patented by Lightyear Technologies Inc. of North Vancouver, British Columbia, Canada. Other examples of exfoliated transition metal dichalcogenide monolayers, applicable to this invention, comprise NbS₂, WS₂, TaS₂, MoSe₂, NbSe₂, WSe₂, or TaSe₂. All of the above examples of the monolayers shall hereinafter be referred to as “TDM.” Generally, TDM is in the form of sheets having a thickness in the atomic range and other dimensions in the 50 to 500A range. The sheets are homogeneously suspended in a liquid and “adhere” to various materials when the latter are immersed in the suspension. Also, the sheets are essentially hydrogen selective membranes in that they are transparent to hydrogen, but impermeable to O₂, CO₂, CO, CH₃OH, H₂O, and other larger molecules. Thus, materials that are sensitive to O₂, CO₂, CO, CH₃OH, and H₂O may be protected by being encapsulated in, coated with, or impregnated with a monolayer or monolayers of TDM.

In one embodiment, the TDM is used to purify and enrich H₂ fuel streams fed to fuel cells from, for example, a fuel processing unit. Such streams would typically comprise CO₂, CO, and CH₃OH. Purification and enrichment of such a H₂ fuel stream is accomplished by applying a layer or layers of the TDM to a porous membrane. The H₂ fuel stream is then passed adjacent the TDM-coated porous membrane. The H₂ is able to pass through the membrane, while the other components in the stream are not.

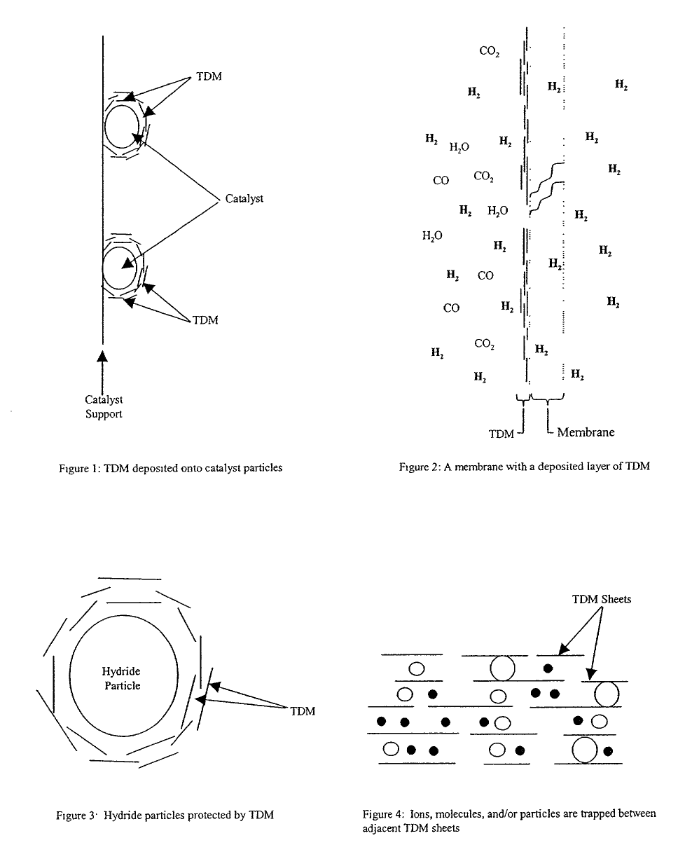

Another embodiment is directed to a method for preventing the poisoning of the Pt catalyst used in fuel cells, particularly at the anode, by CO. At the relatively low operating temperatures of PEM fuel cells, Pt catalysts may be severely poisoned by even trace amounts (1-10 ppm) of CO, a species typically present in H₂-rich reformate streams in much larger concentrations. Using TDM to prevent such poisoning is accomplished by encapsulating the Pt catalyst in TDM. For example, the fuel cell anode may be dipped into a TDM suspension, thereby coating the Pt particles with mono, bi, or multiple layers of the TDM. Such encapsulation of Pt catalyst particles is illustrated in FIG. 1. Related embodiments are directed to Pt catalyst particles, such as those used in fuel cells, that are encapsulated by a layer or layers of TDM; to an MEA that comprises the same; and to a fuel that contains such an MEA.

Another embodiment is directed to a method for preventing oxidation, during cell reversal of a catalyst carbon support used on the anode of fuel cells. During cell reversal associated with fuel starvation, the carbon catalyst support is oxidized by reaction with water and is converted to CO₂. The result is loss of supported catalyst. The carbon support is coated with TDM to prevent contact with water and resulting oxidation. Either the Pt catalyst used for H₂ oxidation separately, or the whole anode may be coated with TDM using basically the same method described above for encapsulating Pt catalyst particles. In this case, if an oxygen evolution catalyst is used to oxidize water trapped in the catalyst layer on the anode, it is added separately to the anode as an admixture or in a bilayer structure on top of the Pt catalyst used for H₂ oxidation (as there needs to be contact between the oxygen evolution catalyst and water for the oxygen evolution reaction to occur). Related embodiments are directed to a catalyst carbon support, used on the anode of a fuel cell, that is coated with a layer or layers of TDM; to an MEA that comprises the same; and to a fuel cell that contains such an MEA.

In a further embodiment, similar to the embodiment described in the preceding paragraph, TDM is used to coat, also by basically the same method described above for encapsulating Pt catalyst particles, a carbon catalyst support on the cathode to prevent oxidation of the carbon. In the absence of coating with TDM, the carbon support is slowly oxidized over time. The oxidation leads to the cathode becoming hydrophilic, which in turn leads to flooding and associated mass transport losses. The oxidation also results in loss of the catalyst on the cathode and associated kinetic losses. Such losses are obviated by coating the carbon support with TDM. Related embodiments are directed to a carbon catalyst support, used on the cathode of a fuel cell, that is coated with a layer or layers of TDM; to an MEA that comprises the same; and to a fuel cell that contains such an MEA.

In yet a further embodiment, TDM is used to prevent crossover of methanol from the anode to the cathode of a fuel cell through the PEM. Methanol crossover is a problem with DMFCs, where a mixture of methanol and water are used as the fuel for the fuel cells. Methanol crossover is also a problem where fuel cells are fed a H₂-rich reformate stream having higher levels of methanol, the higher levels being allowed for the purpose of reducing reformer size and complexity. Crossover of methanol presents a number of problems. Crossover methanol is electrochemically oxidized at the cathode, resulting in a lowering of the operating potential of the cathode. The crossover methanol is also lost to productive electrochemical oxidation at the anode. Also, it can react with the oxygen in the cathode air stream, reducing the amount of oxygen available for the cathodic electrochemical reduction reaction. Prevention of such crossover is provided by providing a layer or layers of TDM to form a TDM film at the interface of the PEM and one of the catalyst layers comprised in the MEA. The TDM layer or layers, forming a TDM film, may be placed at the anode/PEM interface, between two PEM sheets, or at the cathode/PEM interface. The TDM film allows the passage of protons, but not the passage of methanol. The layer or layers of TDM, forming a TDM film, may be coated, prior to assembly of the MEA, on one or more surfaces of a PEM that is essentially a solid film. In another embodiment, where the PEM is a composite membrane, the PEM may be impregnated with the TDM. In yet other related embodiments, the number of layers in the TDM film is tailored to allow partial, rather than complete, blockage of methanol. FIG. 2 illustrates a membrane, such as a PEM, with a deposited layer of TDM. Further related embodiments are directed to MEAs comprising a layer or layers of TDM, forming a TDM film, the latter being sandwiched between PEM sheets, or between the PEM and either the anode or cathode of the MEA, and to fuel cells containing such MEAs. Finally, another related embodiment is directed to a MEA comprising a PEM that is a composite membrane impregnated with TDM.

Another embodiment is directed to preventing water crossover from the anode and cathode through the PEM of a fuel cell by the same methods of using a layer or layers of TDM, forming a TDM film, as those described in the preceding paragraph. Water crossover makes effective water management in fuel cells difficult and causes a number of problems. For example, water crossover in DMFCs from the anode to the cathode can contribute to mass transport losses at the cathode. This is prevented using any of the methods described in the preceding paragraph. Also, placement of TDM films, generally as described in the preceding paragraph, is used to prevent dehydration and promote humidification of the PEM. The particular placement of the TDM film may result in different humidification of the PEM, and have different effects on overall water management in the MEA. For example, in a DMFC, when the TDM film is placed at the cathode/PEM interface, humidification of the PEM occurs from equilibrium with the aqueous methanol solution at the anode. As another example, in a fuel cell using H₂ as the fuel, if a PEM is coated with a TDM film on the anode side, the water produced by the cathode reaction should be retained. Alternatively, in a counterflow operation, the PEM may be coated on part of its surface regions only, and at opposite sides, where the regions coated are the dry inlet regions for each gas (i.e. the wet outlet region of the cathode is excluded). The result is improved water retention by the PEM, and, thus, improved PEM proton-conductivity and fuel cell performance. Also, the PEM is less prone to cracking from dehydration.

Another embodiment is directed to preventing degradation of PEMs from chemical and heat exposure by coating PEMs that are film membranes, or by impregnating PEMs that are composite membranes, with TDM. PEMs are susceptible to thinning and formation of holes and cracks due to exposure to by-product species present in the catalyst/PEM interface regions, due to other contaminants coming into contact with the PEM, and due to slow solubilization, enhanced by higher temperatures and the presence of methanol and other chemical species. Coating or impregnating PEM surfaces with TDM eliminates such exposure and associated degradation.

Further embodiments of this invention are directed to using TDM to protect chemical and metal hydrides used for H₂ storage. Chemical hydrides, such as NaBH₄, decompose in an aqueous medium. In one embodiment, these chemicals are protected from exposure to water for H₂ storage applications by being formed into pressed pellets and layered with TDM so as to be thereby encapsulated by the TDM. The method for accomplishing the latter is basically the same as the method described above for encapsulating catalyst particles. Alternatively, in another embodiment, molecules or ions of these chemicals are sandwiched between adjacent TDM layers in an aqueous solution. The method of the latter embodiment is applicable to the Millenium NaBH₄ technology that yields a stable H₂ source while obviating the need for the presently used, highly corrosive stabilizing medium. Metal hydrides are often very sensitive to CO, CO₂, H₂O, and other impurity gases—even at room temperature. Exposure to such impurity gases yields low cycle performance. High sensitivity to such impurity gases has heretofore rendered the use of some metal hydrides, such as TiFe, impractical. Application of a protective layer or layers of TDM to metal hydrides so as to encapsulate the same with the TDM, as illustrated in FIG. 3, eliminates the sensitivity of the metal hydrides to such impurity gases. Related embodiments are directed to chemical and metal hydrides, used for H₂ storage for fuel cell and other applications, comprising a protective layer or layers of TDM that encapsulate the chemical and metal hydrides.

Yet further embodiments of this invention are directed to using TDM to purify and lower the freezing point of the water used to cool fuel cell stacks. One embodiment, directed to purifying the cooling water, passes the cooling water through a TDM filter. In another embodiment, cooling water is purified by suspending TDM sheets in the cooling water, as illustrated in FIG. 4. Ions and molecules reside between adjacent TDM sheets. After several sheets attach to the ions and molecules, the latter precipitate, and the trapped impurities may be filtered out. Another embodiment is directed to using a TDM suspension to lower the freezing point of the cooling water.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A fuel cell system comprising a component coated with a monolayer of an exfoliated transition metal dichalcogenide.

2. The fuel cell system of claim 1 wherein the system comprises a solid polymer electrolyte fuel cell.

3. The fuel cell system of claim 1 comprising a hydrogen purification subsystem wherein the component is a porous membrane in the hydrogen purification subsystem.

4. The fuel cell system of claim 1 comprising a fuel cell wherein the component is a catalyst in an electrode of the fuel cell.

5. The fuel cell system of claim 1 comprising a fuel cell wherein the component is a catalyst support in an electrode of the fuel cell.

6. The fuel cell system of claim 1 comprising a fuel cell wherein the component is an electrode of the fuel cell.

7. The fuel cell system of claim 2 wherein the component is the solid polymer electrolyte in the fuel cell and the solid polymer electrolyte is coated on one major surface with the monolayer of the exfoliated transition metal dichalcogenide.

8. The fuel cell system of claim 2 wherein the component is the solid polymer electrolyte in the fuel cell and the solid polymer electrolyte is coated on both major surfaces with the monolayer of the exfoliated transition metal dichalcogenide.

9. A fuel cell system comprising a cooling water subsystem wherein the cooling water subsystem comprises a monolayer of an exfoliated transition metal dichalcogenide.

10. The fuel cell system of claim 9 wherein the monolayer is comprised within a cooling water filter.

11. The fuel cell system of claim 9 wherein the cooling water comprises a suspension of the monolayer.

12. A method of providing a barrier in a fuel cell system to block the passage of a species, the method comprising coating a component in the fuel cell system with a monolayer of an exfoliated transition metal dichalcogenide.

13. The method of claim 12 wherein the system comprises a solid polymer electrolyte fuel cell.

14. The method of claim 12 wherein the system comprises a hydrogen purification subsystem and the component is a porous membrane in the hydrogen purification subsystem.

15. The method of claim 12 wherein the system comprises a fuel cell and the component is a catalyst in an electrode of the fuel cell.

16. The method of claim 12 wherein the system comprises a fuel cell and the component is a catalyst support in an electrode of the fuel cell.

17. The method of claim 12 wherein the system comprises a fuel cell and the component is an electrode of the fuel cell.

18. The method of claim 13 wherein the component is the solid polymer electrolyte in the fuel cell.

19. A method of purifying cooling water in a cooling water subsystem in a fuel cell system, the method comprising incorporating a monolayer of an exfoliated transition metal dichalcogenide in the cooling water subsystem.

20. A method of lowering the freezing point of cooling water in a cooling water subsystem in a fuel cell system, the method comprising incorporating a suspension of a monolayer of an exfoliated transition metal dichalcogenide in the cooling water.
